(19) United States
(12) Patent Application Publication
(10) Pub. No.: US 2014/0060727 A1
(43) Pub. Date: Mar. 6, 2014

(54) POROUS COMPOSITE BLOCK, FILTER ASSEMBLY, AND METHOD OF MAKING THE SAME

(71) Applicants: Mark R. Stouffer, Middletown, CT (US); Eric C. Pemberton, Southington, CT (US)

(72) Inventors: Mark R. Stouffer, Middletown, CT (US); Eric C. Pemberton, Southington, CT (US)

(21) Appl. No.: 14/112,691

(22) PCT Filed: Apr. 11, 2012
(86) PCT No.: PCT/US12/33119

§ 371 Date: Oct. 18, 2013

Related U.S. Application Data
(60) Provisional application No. 61/486,510, filed on May 16, 2011.

(51) Int. Cl. B29C 39/10

(52) U.S. Cl. CPC B29C 39/10
USPC 156/245

(57) ABSTRACT

A porous composite block includes a plurality of primary structures bonded to one to another. Each primary structure comprises adsorptive media particles bonded together by a polymeric binder. A filter assembly including the porous composite block, and a method of making the porous composite block are also disclosed.

### FIELD

The present disclosure broadly relates to porous composite blocks, filter products incorporating such porous composite blocks, and methods of making porous composite blocks.

### BACKGROUND

Porous composite blocks including adsorptive material are useful as filtration media in the treatment of liquid feed streams such as in water treatment applications. For example, one type of porous composite block, a carbon block filter includes activated carbon particles bound together by a polymeric binder material. A polyolefin material such as ultra high molecular weight polyethylene (UHMW PE) may serve as the binder. Carbon block filters provide treatment capabilities comparable to and often better than those of a loose bed of carbon particles when used in the removal of organic contaminants from water. Moreover, carbon block filters are compact in their construction and can be handled with a reduction in the messiness commonly associated with the handling of loose beds of carbon particulate.

Porous composite blocks may be made for use in any of a variety of filtration applications by including appropriate components in the construction of the block; for example, in addition to activated carbon or in place of it. Such components can include, for example, ion exchange resin, adsorbent materials; metal ion exchange zeolite sorbents; activated aluminas; silver-based, zinc-based, and halogen-based antimicrobial compounds; acid gas adsorbents; arsenic reduction materials; iodinated resins; and textile fibers.

Although porous composite blocks have been widely applied to a variety of filtration applications, the technology has been plagued by long-recognized limitations. One such limitation has been in the treatment of filtration feeds having high sediment content. For example, carbon block filters have been used for the purification of residential water at the point of entry (POE) to a home. Residential water supplies may have high sediment content, and carbon block filters have suffered from a low tolerance for such sediment. As a result, carbon block filters often foul (e.g., become obstructed) within relatively short periods of time following an initial exposure to a high-sediment feed stream containing silt, lime scale, and/or rust.

### SUMMARY

In one aspect, the present disclosure provides a porous composite block comprising a plurality of primary structures bonded one to another, wherein each of said plurality of primary structures comprises respective first adsorptive media particles bonded together by a respective primary polymeric binder, wherein a respective tortuous primary network of pores extends throughout each primary structure, and wherein at least 80 percent by weight of the primary structures, if removed from the porous composite block, would not pass through a 500 micron screen.

In another aspect, the present disclosure provides a filter assembly comprising at least one porous composite block according to the present disclosure, the porous composite block being enclosed within a housing having an inlet opening and an outlet opening and configured to direct a flow of liquid entering the inlet opening, through the porous composite block, and then through the outlet opening to exit the filter assembly.

In yet another aspect, the present disclosure provides a method of making a porous composite block, the method comprising:

providing components comprising a plurality of primary structures, each primary structure comprising primary adsorptive media particles bonded together by a first polymeric binder and defining a tortuous primary network of pores extending throughout the primary structure;

placing at least a portion of the plurality of primary structures in a cavity of a mold;

heating said at least a portion of the plurality of primary structures to soften the thermoplastic polymeric binder and bond said at least a portion of the plurality of primary structures together; and

cooling the mold to solidify the thermoplastic polymeric binder and form the porous composite block.

Conventional porous composite blocks made of activated carbon particles include small interstitial spaces between the carbon particles corresponding to the aforementioned primary network of pores. The interstitial spaces collectively form a tortuous and complex porous pathway through which a liquid feed stream can pass during a filtration operation. Where the size and shape of the activated carbon particles permits a dense packing of particles during formation of the block, the resulting porous composite blocks generally have smooth outer surfaces, with particles of activated carbon arranged in a tight packing throughout the porous composite block.

Advantageously, porous composite blocks according to the present disclosure can trap sediment in volume created by the protuberances, and optionally within void space within the porous composite block exterior to the primary structures. This endows the blocks with substantially higher tolerances for sediment levels than has previously been available. Accordingly, the present disclosure provides an effective solution for increasing the sediment removal capacity for porous composite block filters (e.g., carbon block filters). Further, articles according to the present disclosure can be fabricated according to methods disclosed in the present disclosure using recycled scrap material; for example, using discontinued porous composite block filters, manufacturing waste, or other scrap material.

As used herein:

the terms “polymer” and “polymeric” refer to organic polymers;

the terms “mesh” and “mesh size” refer to U.S. mesh size;

the term “z micron screen”, where z is a number, refers to a wire screen having z micron by z micron square openings;

the expression “m inches×n inches” in reference to particle size, wherein m and n are numbers, refers to particles that pass through a wire screen having m inches×m inches square openings, but do not pass through a screen with a wire screen having m inches×m inches square openings.

the expression “m×n mesh” in reference to particle size, wherein m and n are numbers, refers to particles that pass through a wire screen with U.S. mesh size m, but do not pass through a screen with U.S. mesh size n.

the expression “m inches×n mesh” in reference to particle size, wherein m and n are numbers, refers to particles that pass through a wire screen having m inches×m inches square openings, but do not pass through a screen with U.S. mesh size n.

The features and advantages of the present disclosure will be further understood upon consideration of the detailed description as well as the appended claims.

### BRIEF DESCRIPTION OF THE DRAWINGS

FIG. 1A is a schematic cross-sectional view of an exemplary porous composite block 100 according to the present disclosure;

FIG. 1B is a schematic cross-sectional view of primary structure 110 shown in FIG. 1A;

FIG. 2 is schematic cross-sectional view of an exemplary filter assembly 200 according to the present disclosure;

FIG. 3A is a digital micrograph showing a porous composite block 300 prepared according to Comparative Example G; and

FIG. 3B is a digital micrograph showing a porous composite block 310 prepared according to Example 3.

It should be understood that numerous other modifications and embodiments can be devised by those skilled in the art, which fall within the scope and spirit of the principles of the disclosure. The figures may not be drawn to scale. Like reference numbers may have been used throughout the figures to denote like parts.

### DETAILED DESCRIPTION

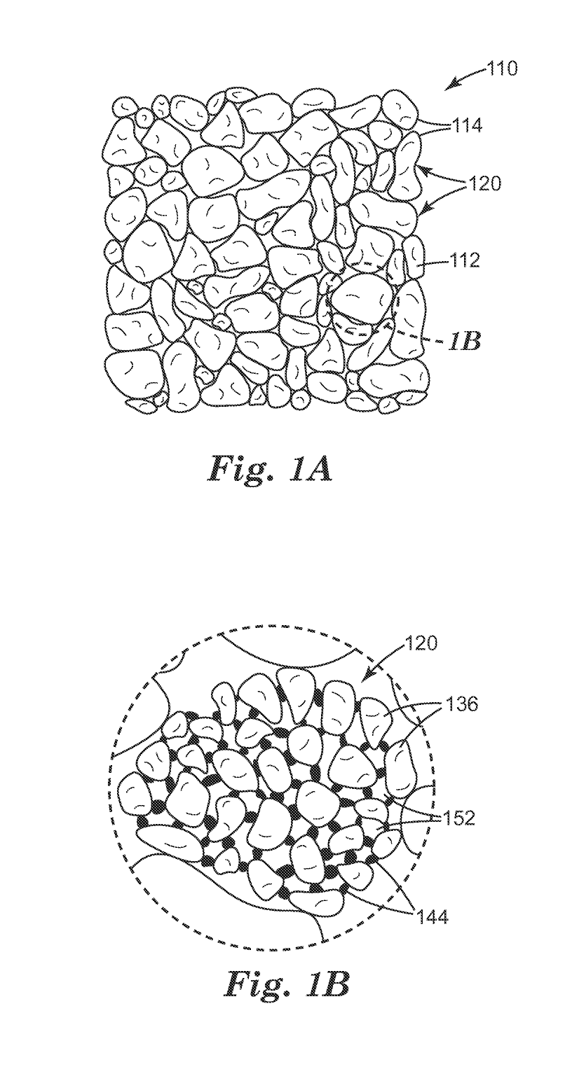

Referring now to FIG. 1A, exemplary porous composite block 110 comprises a plurality of primary structures 120 bonded to one another. Porous composite block 110 has an outer surface 112 comprising optional irregular protrusions 114, which comprise portions of primary structures 120. Referring now to FIG. 1B, primary structures 120 comprise adsorptive media particles 136, bonded to one another by polymeric binder 144. Primary structures 120 each include a tortuous primary network of pores 152 that extends throughout primary structure 120. Primary structures 120 are of sufficient size that at least 80 percent by weight of the primary structures, if removed from the porous composite block, would not pass through a 500 micron screen

Adsorptive media particles suitable for the formation of primary structures herein may be comprise at least one component selected from the group consisting of activated carbons (including, e.g., activated carbon and catalytic activated carbon), lead removal media, diatomaceous earth, antimicrobial media or agents, silicas, zeolites, aluminas, ion exchangers, arsenic removal media, molecular sieves, charge-modified particles, titanium silicates, titanium oxides, metal oxides, metal hydroxides, and combinations thereof. In some embodiments where the porous composite block will be used in the filtration of water, the adsorptive media particles typically comprise activated carbon (e.g., activate carbon derived from ground nutshells). Exemplary commercial activated carbon materials are commercially available from Kuraray Co., Ltd., Tokyo, Japan under the designations “PGW” and “PGWH”.

Additional (secondary) adsorptive media particles may optionally also be incorporated into the structure of the porous composite block as components separate from the primary structures.

In some embodiments, a single grade of primary and/or secondary adsorptive media particles may be used with a corresponding polymeric binder. In other embodiments, a mixture of different grades and/or types of adsorptive media particles may be used with a corresponding polymeric binder; for example, as included in the primary structures described herein. In general, the adsorptive media particles may be of any desired shape or size. In some embodiments, the adsorptive media particles have a length or width of about 6 millimeters (e.g., U.S. mesh size of 6) or less to about 44 microns (e.g., U.S. mesh size of 325), or more. It will be appreciated by those or ordinary skill in the art that other adsorptive media particle sizes are useful in the formation of primary structures, and the present disclosure is not to be limited in any way by the adsorptive media particles sizes or the distribution of adsorptive media particles sizes. In some embodiments, adsorptive media particles having sizes less than about 44 microns may be used. In some embodiments, adsorptive media particles of a single size distribution may be used. In other embodiments, the primary structures may comprise more than one size distribution of adsorptive media particles (e.g., multimodal distribution). In some embodiments, primary structures can include adsorptive media particles having sizes greater than about 0.1, 0.5, 1, or even 4, greater than about 2 millimeters.

In the production of suitable primary structures, a polymeric binder (primary polymeric binder) is used to adhere the individual adsorptive media particles to one another. The polymeric binder may be selected from known polymeric materials including, for example, a polyolefin, polyester, polyether, polyamide, styrenic polymers, cellulosic polymers, acrylic polymers, and combinations thereof. Useful polyolefins include, for example, low density polyethylene, high density polyethylene, ultra-high molecular weight polyethylene, low density polypropylene, high density polypropylene, and combinations thereof. As used, herein, the term “ultra-high molecular weight polyethylene” (UHMW PE) refers to polyethylene having a number average molecular weight (Mₙ) of about 2×10⁶ grams per mole (g/mol) or greater. In some embodiments, the overall binder content of porous composite block according to the present disclosure is typically between about 5 percent by weight and about 50 percent by weight, of the weight of an agglomerate; in some embodiments, between about 10 percent by weight and about 25 percent by weight, and in some embodiments between about 15 percent by weight and about 20 percent by weight, on a dry weight basis.

The polymeric binder is typically supplied in particulate form (especially if it is thermoplastic) during fabrication of the porous composite block, but this is not a requirement. Thermosetting polymeric binders may also be used. Any particle size may be used, but typically polymeric binder particles are in a size range of from about 1 micron to about 5 millimeters.

The primary structures each include a respective tortuous primary network of pores. Typically, the pores result, at least in part, from inefficiencies in packing during formation. Optionally, pores in the primary structures (or even pores external to the primary structures) may be introduced by inclusion of pore-forming materials during formation of the primary structure, or block filter from which the primary structure originated. Examples of pore-forming materials include expanded polypropylene, expanded polyethylene, expanded polystyrene, water-soluble materials (e.g., polyphosphate particles, inorganic salts) that can be washed out of a porous composite block structure, thus leaving void spaces in their space, and combinations thereof.

In general, the primary structures will encompass a range of sizes, shapes, and/or compositions, although this is not a requirement. For example, the primary structures may have a size distribution wherein at least 80, 85, 90, 95, or even at least 99 percent by weight of the primary structures would not pass through an 841 micron screen (U.S. mesh size=20), a 500 micron screen (U.S. mesh size=35), a 400 micron screen (U.S. mesh size=40). In some embodiments, at least 10, 20, 30, 40, or even at least 50 percent by weight of the primary structures will not pass through a screen having openings of 1.0 mm, 1.4 mm, 2.0 mm, 3.3 mm, or even 4.7 mm. For example, in some embodiments, at least 50 percent by weight of the primary structures will not pass through a screen having openings of 4.7 mm.

In various embodiments, primary structures useful in the formation of a porous composite block have a length of about 15 millimeters or less and a width of about 15 millimeters or less. In some embodiments, the primary structures have a length of about 0.1 millimeters (e.g., a U.S. mesh size of 150) or greater and a width of about 0.1 millimeters or greater. In some embodiments the primary structures each have a length in the range from about 15 millimeters to about 0.1 millimeters and a width in the range from about 15 millimeters to about 0.1 millimeters. Those of ordinary skill in the art will understand that the foregoing agglomerate sizes are provided by way of example and are not to be construed as limiting the useful range of agglomerate sizes in any way.

The primary structures may be prepared in any known manner. In some embodiments, the agglomerated are prepared by adhering activated carbon particles together using a suitable binder. The amount of carbon particles in a primary structure may be of a predetermined volume or weight of individual particles. In some embodiments, the amount of individual carbon particles in a primary structure may be randomly determined. As mentioned, materials other than activated carbon may be included in the preparation of the primary structures. In some embodiments, primary structures are prepared from a source block having an initial size larger than that of the primary structures (e.g., a carbon block filter cartridge). In such embodiments, the source block may be obtained from scrap or from a discarded lot of previously manufactured porous composite blocks. In some embodiments, the larger porous composite blocks may be prepared for the purpose of creating an initial source of material that can be further treated to provide a collection of primary structures. The larger porous composite block may be fragmented using any suitable means in order to provide a plurality of primary structures, each of the primary structures being of a size smaller than the initial size of the source block. In the foregoing embodiments, the resulting primary structures may be further reduced in overall size, and the thus formed primary structures may be further processed to achieve a desired particle size distribution (e.g., by sieving the primary structures to obtain a desired maximum particle size and/or a desired minimum particle size). As discussed elsewhere herein, a porous composite block may be formed using a single size distribution of primary structures. In some embodiments, a porous composite block may be formed with two of more (e.g., multimodal) size distributions, and the relative percentages of primary structures from any single agglomerate size distribution may be varied as needed or desired.

In addition to the use of primary structures, other pore-forming material(s) may be included in the construction of a porous composite block. Pore-forming materials may be capable of being dissolved, melted, decomposed, or otherwise treated so that each particle of pore-forming material is removed, its volume is greatly reduced, or it is otherwise physically altered so as to leave a void space in the finished porous composite block. Examples of suitable pore-forming materials include foamed polymer materials that reduce in volume upon heating (e.g., foamed or expanded polymer beads, expanded polypropylene, expanded polyethylene, expanded polystyrene, combinations thereof), water-soluble materials (e.g., inorganic salts, soluble polymers (e.g., cold water soluble polyvinyl alcohol)), and combinations thereof. Pore-forming materials suitable for use in the partial or complete manufacture of the primary structures may also be used.

Typically, the primary structures are irregularly-shaped in that individual primary structures are not of a standard geometric shape (e.g., a cube, sphere, or pyramid), although this is not a requirement. In some embodiments, the primary structures have visually discernible outer boundaries. In some embodiments, the extent of the primary structure is discernible on the basis of composition (e.g., based on the polymeric binder and/or filter media particles). For example, some primary structures may include lead removal media particles and other primary structures may contain activated carbon particles. Likewise, all primary structures may contain the same filter media particles, but some primary structures may include a polyethylene binder, and other primary structures contain a polypropylene binder. In general, the primary structures may be characterized by their sizes; for example, as determined by a standard sieving operation. In some embodiments, the primary structures may be characterized as having a maximum and/or a minimum length as well as maximum and/or a minimum width. Primary structures used in the formation of a porous composite block may comprise a distribution of particle sizes. In other embodiments, the primary structures may comprise a multimodal distribution of sizes wherein primary structures of two or more particle size distributions may be combined in the formation of a single porous composite block.

The primary structures are bonded to one another, either by fusing them one to another or through the use of an optional secondary polymeric binder and/or optional secondary absorptive media particles, to provide the porous composite block.

The optional secondary polymeric binder may is typically in particulate form, but this is not a requirement. This secondary polymeric binder is typically included if the secondary adsorptive media particles are included in the porous composite block. Examples of suitable secondary polymeric binders include primary polymeric binders listed above for inclusion in the primary structures.

In some embodiments, secondary void space may be present, resulting from packing inefficiency of the primary structures in the formation of the block. That is, the secondary void space may be determined by the manner in which the primary structures, and any optional additional components (e.g., secondary binder particles and/or secondary filter media particles) used as basic building blocks of the porous composite block, fit together within the overall construction of the porous composite block. The irregular shapes of the primary structures, when pressed against one another, may create larger secondary void spaces between the primary structures than would normally be created if the adsorption media particles were in another form (e.g., if they were individual or non-agglomerated carbon particles).

Primary structures can be made, for example, by fragmenting or shredding a conventional block filter (e.g., a carbon block filter), or by using scrap generated during block filter fabrication. Many commercial block filters are available and may be used in practice of the present disclosure, although they may contain addition supporting structure that should typically be removed. Suppliers include, for example, 3M Purification Inc., Meriden Conn. and Multi-Pure Drinking Water Systems, Las Vegas, Nev.

Further details concerning porous composite media and block filters that can be converted used as, or converted into, primary structures can be found in U.S. Patent Appl. Publ. Nos. 2011/0042298 A1 (Stouffer et al.); 2010/0243572 A1 (Stouffer et al.); 2007/0222101 A1 (Stouffer et al.); and U.S. Pat. No. 7,169,304 (Hughes et al.); U.S. Pat. No. 7,112,280 B2 (Hughes et al.); and U.S. Pat. No. 7,112,272 B2 (Hughes et al.), the disclosures of which are incorporated herein by reference.

Secondary void space adjacent to the outer surface of the porous composite block is typically of sufficient dimensions that it is capable of trapping sediment within its volume. In some embodiments, secondary void space includes secondary pores having an average diameter in a range from 0.1 millimeter to 15 millimeters. In some embodiments, the total volume of the secondary void space exceeds the total volume of void space due to the primary network of pores from all of the primary structures, although in other embodiments it does not.

In some embodiments, the average diameter of voids and/or pores comprising the secondary void space is less than about 3 millimeters (mm), in some embodiments less than about 2 mm, and in some embodiments less than about 1 mm. Both larger and smaller diameters are also within the scope of the disclosure, and a porous composite block may comprise a plurality of voids and/or pores having different sizes and/or shapes. Void space is typically provided within the internal structure as well as along the outer surface of the porous composite block, although this is not a requirement. In some embodiments, the surface of the porous composite block may have a nodular surface texture if viewed by an unaided human eye. In some embodiments, voids and/or pores comprising the secondary void space may be large enough to be visible to the human eye when viewing the surface of the porous composite block as well as being visible throughout the block's construction (e.g., when viewing a cross-sectioned portion of a porous composite block). The presence of secondary void space adjacent to the outer surface of the composite block endows each porous composite block with an improved tolerance for the presence of sediment in a liquid feed stream so that the block experience a longer useful life as filtration media in the filtration of liquid streams with significant levels of particulate (e.g., sediment).

Porous composite blocks according to the present disclosure can be used as a filtration media in any filtration application wherein the feed stream includes significant amounts of particulate material (e.g., sediment). The porous composite blocks described herein are useful for filtering liquid feed streams including, for example, water feed streams such as those at the point of entry (POE) to a home or dwelling, potable water, non-potable water, industrial liquids, and/or fluids.

In some embodiments, porous composite blocks are formed in a cylindrical configuration with a hollow core space forming an inner diameter and the outermost surface of the block providing an outer diameter; however, other configurations may also be used. Fluid flow through a porous composite block can be directed first into the inner core to the inner diameter of the block, then through the composite media (e.g., activated carbon), and finally emerging from the outer surface of the block. In other configurations, flow can be directed from the outer surface, through the composite filtration media and into the inner core of the block. Either of the foregoing flow configurations may be suitable for the embodiments of porous composite blocks described herein. A porous composite block filtration media is typically placed in a housing that is configured to direct the flow of fluid through the composite material; for example, as previously described.

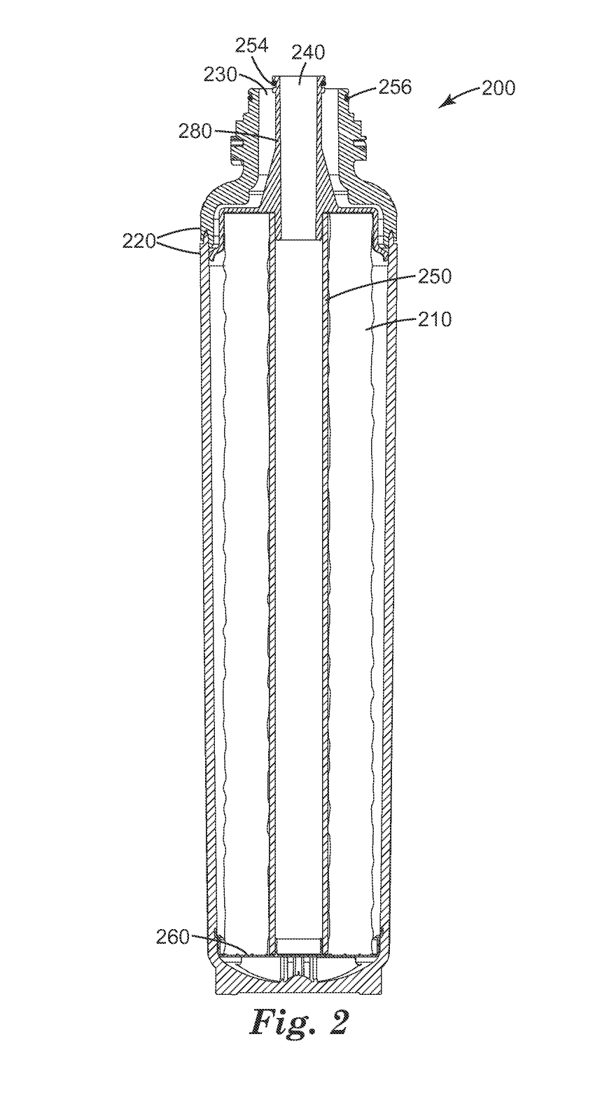

Referring now to FIG. 2, exemplary filter assembly 200 comprises porous composite block 210 according to the present disclosure. Porous composite block 210 is enclosed within housing 220 and is confined by end caps 260, 280 affixed (e.g., glued) thereto. Housing 220 has inlet opening 230. End cap 280 has outlet opening 240. Filter assembly 200 is configured to direct a flow of liquid entering through inlet opening 200, through porous composite block 210, and then through outlet opening 240. O-rings 254,256 ensure a tight seal when filter assembly 200 is connected to a fluid supply. Optional porous sleeve 250 may help to regulate fluid flow through porous composite block 210. Housing 220 may comprise any suitable material; for example, depending on the intended application. For example, for water filters housing 220 may comprise an engineering thermoplastic such as a polyacetal, polyamide, polyester, or polycarbonate.

Optionally, the porous composite block may be disposed within an optionally pleated prefilter sleeve (not shown), so that the filtrate passes through the prefilter before passing through the porous composite block. The prefilter may be made, for example, of polypropylene, polyester, polyamide, resin-bonded fibers, binder-free fibers, synthetics, sintered materials, metals, ceramics, yarns, special filter paper, polymer membranes, or any combination thereof. A protective netting may be disposed around the prefilter, if present.

Porous composite blocks according to the present disclosure may have any desired shape; for example, depending on the intended application. Examples include hollow cylinders and discs. Many filter designs are known for use with porous filter blocks, and all may be used in conjunction with porous composite blocks according to the present disclosure. The porous composite block(s) may be the sole filtration media in the filter assembly, or the block(s) may be operatively associated with one or more other forms of filtration media including, for example, pleated filtration media, membrane(s), one or more beds of particulate media (e.g., ion exchange resin) or the like. Depending on the specific application, the additional filtration media may be located upstream or downstream from the porous composite block(s). In embodiments wherein the system is used in a filtration application for the treatment of a liquid feed stream having high sediment content, the porous composite block may be the primary filtration media. However, an upstream prefilter may be included within such a system and/or a downstream media may be used for additional filtration or treatment of the feed stream. In some embodiments, the porous composite block may be used as a downstream filtration media such as, for example, in water softening systems

Porous composite blocks can be prepared, for example, by a method such as that described below.

In a first step, a plurality of primary structures as described hereinabove and any optional additional components are combined in a mold cavity. Examples of optional additional components include polymeric binder particles, activated carbon, lead removal media, diatomaceous earth, antimicrobial media or agents, silicas, zeolites, aluminas, ion exchangers, arsenic removal media, molecular sieves, charge-modified particles, titanium silicates, titanium oxides, metal oxides, metal hydroxides, and combinations thereof. In some embodiments, the optional additional components comprise discrete particles of activated carbon, wherein the discrete particles of activated carbon have an average length and width greater than 44 microns.

The primary structures may be prepared according to conventional techniques, but are preferably prepared by fragmenting one or more existing block filters (which may be the same or different in terms of composition) such as, for example, a carbon block filter. Such block filters are typically compressed during fabrication so as to create a tortuous primary network of pores that extends through adsorption media particles bonded on to another by a polymeric binder. Typically, the polymeric binder is thermoplastic, but this is not a requirement. Block filters may be converted into smaller fragments by any suitable method including, for example, cutting, impact, shredding, and/or chipping. The fragments may be sorted by size, if desired. In some embodiments, the plurality of primary structures comprises a multimodal (e.g., bimodal or trimodal) distribution of sizes. Scrap material resulting during manufacture of the block filters may also be advantageously used.

In a second step, the contents of the mold cavity are heated to a temperature sufficient to soften the polymeric binder sufficiently that it can flow within the chosen molding time and cause bonding at some or all points of contact between the primary structures to form a porous composite block. The contents of the mold cavity may be compacted (e.g., by vibration or mechanical shock), typically under the force of gravity. Application of compressive force may be used, but excessive compressive force may tend to reduce the size of the tortuous secondary network of pores and/or their total void space volume.

The selection of temperature will depend on the nature of the polymeric binder, and will be readily apparent to those of skill in the art. For example, for ultra high molecular weight polyethylene binder (melting point of about 144-152° C.) a temperature of 175° C. for about 1 to 2 hours is typically effective.

In a third step, the mold is cooled sufficiently to enable removal of the resultant porous composite block.

Initially, primary structures and optional other components used to form a porous composite block are placed in a container suitable for mixing the components to provide a substantially uniform composition which may be further processed to provide the porous composite block. Suitable containers will be selected by those of ordinary skill in the art based on the volume of materials needed, the types of materials included in the porous composite block, and the like. In some embodiments, the component materials may be mixed directly within a mold cavity. In some embodiments, vibration is used while filling the mold. In some embodiments, a technique known as “impulse filling” is used to fill the mold. Impulse filling applies a limited series of discrete displacements to the mold or to the table or surface on which the mold sits. Impulse filling is further described in U.S. Patent Appl. Publ. No. 2007/0222101 A1 (Stouffer et al.). While vibration of a mold involves a high rate of displacements (e.g., frequency greater than about 600 displacements per minute) impulse filling utilizes a low rate of displacements, typically using a frequency in the range 5 to 120 displacements per minute. In some embodiments, the displacements are at a rate of about 20 displacements per minute (e.g., every 3 seconds). In other embodiments, the displacements are at a rate of about 30 displacements per minute (e.g., every 2 seconds).

Filling of the mold may optionally include an axial compression step either during or after baking of molds. The compression step is controlled to compress the material within the mold cavity to a fixed length. The compression step can be advantageous because: (1) the porous composite block is molded to its final shape, eliminating the need for further processing and reducing scrap; and (2) when combined with impulse filling, the density and the porosity of the porous composite block are highly uniform, often allowing for the manufacture of porous composite blocks with more controlled performance characteristics.

As known by those of ordinary skill in the art, the porous composite blocks may then made into filters by gluing end caps on the carbon blocks and inserting the end capped blocks into housings.

Optionally, molds can be filled to a reproducible maximum uncompressed density by impulse filling. The molds are then heated and are compacted by a fixed axial distance to provide porous composite blocks with a substantially uniform density and porosity. In this manner, the resulting porous composite blocks are typically substantially uniform across their length, and may exhibit better flow properties and filtration performance, and may be less susceptible to preferential flow. Further, molding blocks to a uniform density across their length can facilitate the manufacture of longer blocks and it can also allow useful porous composite blocks to be cut from longer sections of composite material as a cost savings measure.

Molds subjected to axial compression typically allow for less shrinkage of material so that the material does not appreciably shrink from the walls of the mold during cooling, and the reduced shrinkage typically requires an increase in force to remove a porous composite blocks from its mold. In the absence of equipment modifications to facilitate the removal of the porous composite blocks upon the completion of the manufacturing process, the increased force during ejection of the molded porous composite block may possibly damage the mold. To address these problems, some embodiments of the process of making porous composite blocks utilize a mold that is slightly tapered in the axial dimension. The taper can be machined into a mold cavity and, in some embodiments; a suitable taper may be between about 0.5 to about 1 degree. The resulting composite will have a wider diameter at one end than at the other end thereof. In some embodiments, a taper of about 0.8 degrees or about 1 degree over about 25 percent of the carbon block length is sufficient to form porous composite blocks using axial compression, which can then be removed from the molds with substantially less force than would be required in the absence of such a taper. In the absence of the foregoing taper, the porous composite blocks may be removed from the mold cavities by ejection using higher force, using highly polished molds, or coating the mold surfaces with a release coating that reduces the required ejection force.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Procedure for Making a Porous Block

Weighed amounts of activated carbon, binder and other components (e.g., lead reduction media, pore forming material) were charged into a 5-gallon (22-L) drum. The contents of the drum were mixed by rapid stirring at a rate of about 600 rpm for about 3 minutes. The resulting mixture was filled into a mold (aluminum pipe with top and bottom plate and mandrel), and the mold was secured to a filling table. The mold was filled while subjecting the table to discreet vertical displacements, for example using a pneumatic rapper or a hammer. Vertical displacements (or impulses) were applied on the table approximately every two seconds for about three minutes, or until the material in the mold was completely compacted. The mold was then heated in a convection oven. Heating time depended on the diameter of the mold and typically ranged 1-2 hours. The mold was cooled to room temperature and the resulting porous composite blocks were ejected from the molds. The resulting porous block was made into water filters by gluing end caps on the carbon blocks and inserting the end-capped porous block into a housing.

### Procedure for Determining Sediment Life

Influent water was spiked with A4 fine test dust (ISO 12103-1 test dust from Powder Technology Inc., Burnsville, Minn. at a concentration of 0.13 grams/gallon (0.030 g/L). Differential pressure was monitored throughout the test. The sediment life was reported as the grams of dust throughput to the filter until the pressure drop across the filter rose 35 psi above the initial pressure drop.

### Comparative Example A

A commercially available point of entry filter (from 3M Purification Inc.) identified as product AP917 “Whole House Filter System” was tested as a comparative example. This product consisted of activated carbons (from Kuraray Co., Tokyo, Japan and designated as “PGWH”) and UHMW PE binders (obtained from Ticona, Florence, Ky., under the designations “GUR 2126 and GUR 2122) and was in the form of a hollow cylinder, 16.8 inches (42.6 cm) long porous carbon block wrapped with a pleated prefilter. The diameter of the block with the pleat pack was about 3.5 inches (8.9 cm). The product had a rated chlorine life of 100,000 gallons (3.8×10⁵ L) at a flow rate of 10 gallons/minute (38 L/min).

Sediment life was evaluated according to the Procedure for Determining Sediment Life, above. The measured sediment life for the commercial filter was 9 grams. An inspection of the filter after the Sediment life test indicated that particulate built up on the outer surface of the porous composite block caused rapid plugging of the media.

### Comparative Example B

Comparative Example A was repeated, except that the pleated prefilter was first removed. Sediment life was 9 grams. Examination of the filter after testing showed a smooth surface of a carbon block.

### Comparative Example C

A porous carbon block was made according to the Procedure for Making a Porous Block (above) using a coarse activated carbon. The block consisted of 90 percent by weight activated carbon (PGWH from Kuraray Co., 20×40 mesh) and 10 percent by weight polymeric binder (GUR 2126 UHMW PE from Ticona). Sediment life was evaluated according to the Procedure for Determining Sediment Life, above, and the measured sediment life was 14 grams.

### Comparative Example D

A porous carbon block was made according to the Procedure for Making a Porous Block (above). The block was formulated by blending 84 percent by weight activated carbon (Kuraray Carbon PGWH 60×150 mesh); 10 percent by weight UHMW PE (Ticona GUR 2126); 6 percent by weight of expanded polypropylene beads (from JSP Corporation, Tokyo, Japan, under the designation “ARPRO EPP”, Lot 5495) as a pore forming material having an approximate density of 0.1 g/mL and an average particle size of 2.5 mm. A hollow cylindrical block was molded to a 3.5 inches (8.9 cm) outside diameter and 0.75 inch (1.9 cm) inside diameter. The mold was filled by impulse filling and cured at 200° C. to assure melting of the polypropylene beads. Upon curing, the polypropylene beads left larger pores and surface roughness in the carbon monolith. The resultant block was trimmed to 16.8 inches (42.7 cm) in length, and was evaluated according to the Procedure for Determining Sediment Life, above. The measured sediment life was 73 grams. Inspection of the block suggested that particulate in the influent water was captured both on the surface of the block and throughout the depth of the block because of the presence of the void spaces.

### Comparative Example E

A porous carbon block was made according to the Procedure for Making a Porous Block (above). The block was formulated by blending 81 percent by weight of activated carbon (Kuraray Co., PGWH, 60×150 mesh); 8 percent by weight of GUR 2126 UHMW PE from Ticona; 10 percent by weight of GUR 4150-3 UHMW PE from Ticona; and one percent by weight expanded polystyrene beads (from American Foam and Packaging Inc. Phoenix, Ariz., as “EPS BBF Virgin”) as a pore forming material having an approximate density of 0.012 g/ml and an average particle size of 2 mm. The block was molded to a 3.5 inches (8.9 cm) outside diameter and 0.75 inch (1.9 cm) inside diameter. The mold was filled by impulse filling and cured at 175° C. Upon curing the polystyrene beads left visible void spaces in the carbon monolith and also increased surface roughness. The resultant block was trimmed to 16.8 inches (42.7 cm) in length, and was evaluated according to the Procedure for Determining Sediment Life, above. The measured sediment life was 1170 grams.

### Comparative Example E

A porous carbon block was made according to the Procedure for Making a Porous Block (above). The block was formulated by blending 68 volume percent activated carbon (Kuraray Carbon PGWH 60×150 mesh); 18 volume percent UHMW PE (Ticona GUR 2126); and 14 volume percent granular polyphosphate scale inhibitor (obtained from BK Giulini GmbH as “SILIPHOS”) which was intended to also act as a pore forming material. The block was molded to a 3.5 inches (8.9 cm) outside diameter and 0.75 inch (1.9 cm) inside diameter. In this example, the concentrations of components are given in volume percent because of large density differences between components. The mold was filled by impulse filling and cured at 175° C. The resultant block was trimmed to 16.8 inches (42.7 cm) long, flushed with water for 4 days (24 hours per day), and then evaluated according to the Procedure for Determining Sediment Life, above. The measured sediment life was 14 grams.

### Fragmentation of Carbon Blocks

Five carbon blocks were collected, corresponding to a range of formulations and applications. They had compositions as follows:

Block 1: 8 percent by weight of METSORB HMRP 50 Lead Reduction Media from Graver Technologies, Glasgow, Del.; 5 percent by weight of NUCHAR AQUAGUARD activated carbon, 80×325 mesh, MeadWestVaco Corp., Richmond, Va.; 10 percent by weight of coconut carbon, PGW-120 MP (D₁₀>20-50 microns, D₅₀=110-140 microns, D₉₀<220 microns), from Kuraray Co., Tokyo, Japan; 54 percent by weight of coconut carbon, PGW-100 MP (D₁₀>4.2 microns, D₅₀=70-110 microns, D₉₀=135-170 microns) from Kuraray Co.; 5 percent by weight of NUCHAR AQUAGUARD activated carbon powder, −325 mesh, from MeadWestVaco Corp.; and 18 percent by weight of GUR 2126 UHMW PE polyethylene powder from Ticona.

Block 2: 40 percent by weight of coconut carbon, PGW-120 MP from Kuraray Co.; 14 percent by weight of coconut carbon, PGW-100 MP from Kuraray Co.; 7 percent by weight of METSORB HMRP 50 Lead Reduction Media from Graver Technologies; 11 percent by weight of GUR 2126 UHMW PE polyethylene powder from Ticona; 16 percent by weight of GUR 4150-3 UHMW-PE polyethylene powder from Ticona; 7 percent by weight of NUCHAR AQUAGUARD activated carbon powder, 80×325 mesh, MeadWestVaco Corp.; and 5 percent by weight of NUCHAR AQUAGUARD activated carbon powder, −325 mesh, from MeadWestVaco Corp.

Block 3: 10 percent by weight of GUR 2122 UHMW PE polyethylene powder from Ticona; 15 percent by weight of GUR 2126 UHMW PE polyethylene powder from Ticona; 10 percent by weight of AQUASORB LT Ag 0.5 percent by weight silver impregnated activated carbon from Jacobi Carbons AB, Kalmar, Sweden; 65 percent by weight of PGW-120 MP powdered carbon (D₁₀=50-90 microns, D₅₀=130-180 microns, D₉₀<230 microns), from Kuraray Co.

Block 4: 20 percent by weight of GUR 2122 UHMW PE polyethylene powder from Ticona; 25 percent by weight of GUR 4150-3 UHMW PE polyethylene powder from Ticona; 45 percent by weight of R8325C-AW coconut shell carbon from Carbon Resources, Oceanside, Calif.; and 10 percent by weight of coconut shell carbon, 0.5% Ag from Jacobi Carbons.

Block 5: 8 percent by weight of METSORB HMRP 50 Lead Reduction Media from Graver Technologies; 14 percent by weight of GUR 2126 UHMW PE polyethylene powder from Ticona; 16 percent by weight of GUR 4150-3 UHMW PE polyethylene powder from Ticona; 34 percent by weight of coconut carbon, PGW-120 MP, from Kuraray Co., Tokyo, Japan; and 28 percent by weight of coconut carbon, PGW-100 MP from Kuraray Co.

Blocks (roughly equal volumes of each type) were pulverized in a blender with a pineapple blade chopper. The resulting material was sieved into a variety of size fractions from 0.5 inch (1.3 cm)×0.25 inch (0.64 cm) to 50×150 mesh using a Rotap screen system. The material (FRAGMENT MIX) was used as a raw material for subsequent experiments.

### Example 1

Porous composite blocks were made using FRAGMENT MIX prepared above, according to the following formulation:

| MATERIAL | PERCENT BY WEIGHT |
|---|---|
| FRAGMENT MIX, | 25 |
| ¼ inch × ½ inch (0.6 cm × 1.3 cm) | |
| FRAGMENT MIX, | 15 |
| ¼ inch (0.6 cm) × 4 mesh (4.76 mm) | |
| FRAGMENT MIX, 4 × 8 mesh | 15 |
| FRAGMENT MIX, 8 × 12 mesh | 10 |
| FRAGMENT MIX, 12 × 20 mesh | 10 |
| Kuraray PGWH 60 × 150 | 15 |
| MICROTHENE FN51000 | 5 |
| polyethylene powder from Equistar | |
| Chemicals, LP, Houston, Texas | |
| Ticona GUR 2126 UHMW-PE | 5 |

The porous composite blocks were molded to 3.5 inches (8.9-cm) outside diameter×0.75 inch (1.9 cm) inside diameter. Compression at about 90 lbf (400 N) was applied before heating. The porous composite blocks were cured at 177° C. Compression at about 90 lbf (400 N) was applied after heating and during cooling.

The above blocks were tested for sediment life and for chlorine reduction efficiency and capacity.

Sediment life was evaluated by a gram life test, spiking influent water with A4 fine test. The gram life is reported as the grams of dust throughput to the porous composite block until pressure drop rises to 35 psi (0.24 MPa) above the initial pressure drop. Gram life for this block was 1928 grams and the test lasted for 43,800 gallons (166 kL). The reduction of turbidity during the gram life test averaged 48 percent during the gram life test.

A chlorine reduction test was conducted per NSF 42. Test data indicate that a 16.8 inches (42.7 cm) long block has a capacity exceeding 185,000 gallons (700 kL). The efficiency after 185,000 gallons (700 kL) was 62 percent, exceeding the NSF requirement.

### Example 2

Blocks were made using the raw material of Example 1, according to the following formulation:

| MATERIAL | PERCENT BY WEIGHT |
|---|---|
| FRAGMENT MIX, ¼ inch × ½ inch | 60 |
| (0.64 cm × 1.3 cm) | |
| FRAGMENT MIX, 4 × 20 mesh | 25 |
| MICROTHENE FN51000 | 10 |
| polyethylene powder | |
| Ticona GUR 2126 UHMW-PE powder | 5 |

Blocks were molded to 3.5 inch (8.9 cm) outside diameter×0.75 inch (1.9 cm) inside diameter. Compression at about 90 lbf (400 N) was applied before heating. Blocks were cured at 177° C. Compression at about 90 lbf (400 N) was applied after heating and during cooling.

The above blocks were tested for sediment life and for chlorine reduction efficiency and capacity.

Sediment life was evaluated by a gram life test as discussed in Example 5. Gram life for this block was 2385 grams. The reduction of turbidity during the gram life test averaged over 55 percent during the gram life test.

A chlorine reduction test was conducted per NSF 42. A 16.8 inches (42.7 cm) long block had a capacity exceeding 200,000 gallons (757 kL). The efficiency after 210,000 gallons (794 kL) was 71 percent, exceeding the NSF requirement.

### Comparative Example G

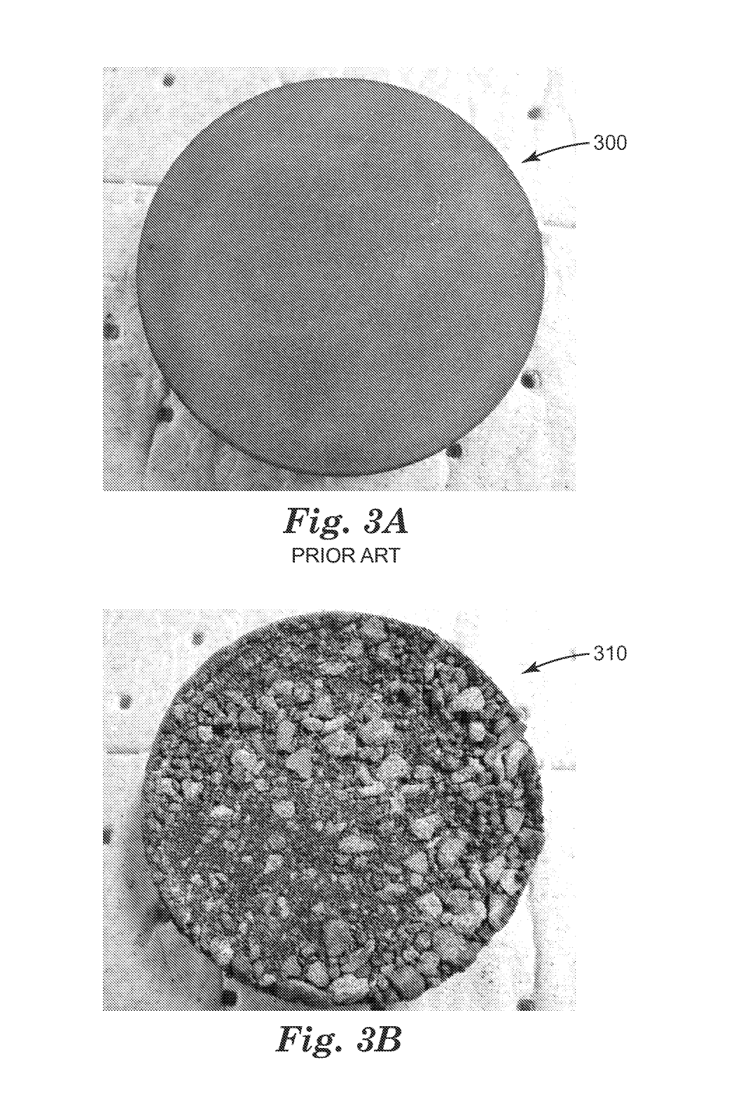

A porous carbon block was made according to the Procedure for Making a Porous Composite Block (above) using a coarse activated carbon. The carbon block consisted of 20 percent by weight of activated carbon (PGW-100 MP from Kuraray Co., Tokyo, Japan), 44 percent by weight of activated carbon (PGW-120 MP from Kuraray Co., Tokyo, Japan), 7 percent by weight of polymeric binder (GUR 2126 UHMW polyethylene powder from Ticona), 19 percent by weight of polymeric binder (GUR 4050-3 UHMW-PE powder from Ticona, Florence, Ky.), and 10 percent by weight of titanium silicate lead reduction media (ATS from BASF Corp, formerly Englehard Corp., Seneca, S.C.). A cylindrical mold was filled by impulse filling. The mold dimension was 3.5 inches (8.9 cm) in diameter and 1.0 inch (2.5 cm) in thickness. The media were compressed at about 30 pounds per foot (lbf) with heating to 180° C. The resultant porous carbon block disc is shown in FIG. 3 as disc 300.

### Example 3

The above blend was also used to make a cylindrical porous carbon block 2.4 inches (6.1 cm) in diameter×10 inches (25.4 cm) in length. The cylindrical porous carbon block was then fragmented in a blender with a pineapple blade chopper. The resulting material was sieved into primary structures with in a size range from ¼ inch×20 mesh using a Rotap screen system.

Porous composite blocks were prepared consisting of 75 percent by weight the above primary structures, 15 percent by weight of activated carbon (PGW 60×150, D₁₀=140-200 microns, D₅₀=190-280 microns, D₉₀=260-380 microns, from Kuraray Co., Tokyo, Japan), and 5 percent by weight of polyethylene powder (MICROTHENE FN51000 polyethylene powder) and 5 percent by weight of polymeric binder (GUR 2126 UHMW-PE powder)

A cylindrical mold was filled by impulse filling. The mold dimension was 3.5 inches (8.9 cm) in diameter and 1.0 inch (2.5 cm) in thickness. The media was compressed at about 30 lbf with heating to 180° C. The resultant disc is shown in FIG. 3B as disc 300.

### Select Embodiments of the Present Disclosure

In a first embodiment, the present disclosure provides a porous composite block comprising a plurality of primary structures bonded one to another, wherein each of said plurality of primary structures comprises respective first adsorptive media particles bonded together by a respective primary polymeric binder, wherein a respective tortuous primary network of pores extends throughout each primary structure, and wherein at least 80 percent by weight of the primary structures, if removed from the porous composite block, would not pass through a 500 micron screen.

In a second embodiment, the present disclosure provides a porous composite block according to the first embodiment, wherein the porous composite block has an outer surface comprising irregular protrusions, and wherein the irregular protrusions comprise a portion of the plurality of primary structures.

In a third embodiment, the present disclosure provides a porous composite block according to the first or second embodiment, wherein secondary void space exterior to the primary structures is present adjacent an outer surface of the porous composite block, and wherein the secondary void space comprises pores having an average diameter in a range from 0.1 millimeter to 15 millimeters.

In a fourth embodiment, the present disclosure provides a porous composite block according to any one of the first to third embodiments, wherein at least 50 percent by weight of the primary structures will not pass through a 4.7 millimeter screen.

In a fifth embodiment, the present disclosure provides a porous composite block according to any one of the first to fourth embodiments, wherein at least a portion of the first adsorptive media particles comprise activated carbon.

In a sixth embodiment, the present disclosure provides a porous composite block according to any one of the first to fifth embodiments, wherein the first adsorptive media particles will pass through a 400 micron screen, but will not pass through a 10 micron screen.

In a seventh embodiment, the present disclosure provides a porous composite block according to any one of the first to sixth embodiments, wherein the plurality of primary structures comprises a multimodal distribution of sizes.

In an eighth embodiment, the present disclosure provides a porous composite block according to any one of the first to seventh embodiments, further comprising second adsorptive media particles external to said plurality of primary structures.

In a ninth embodiment, the present disclosure provides a porous composite block according to any one of the first to eighth embodiments, wherein, if removed from the porous composite block, the at least 80 percent by weight of the second adsorptive media particles will not pass through a 44 micron screen.

In a tenth embodiment, the present disclosure provides a porous composite block according to any one of the first to ninth embodiments, further comprising a second polymeric binder external to said plurality of primary structures.

In an eleventh embodiment, the present disclosure provides a porous composite block according to any one of the first to tenth embodiments, wherein at least one of the primary polymeric binder or secondary polymeric binder is selected from the group consisting of polyethylenes, polypropylenes, and combinations thereof.

In a twelfth embodiment, the present disclosure provides a porous composite block according to any one of the first to eleventh embodiments, wherein at least one of the primary polymeric binder or secondary polymeric binder comprises a high molecular weight polyethylene.

In a thirteenth embodiment, the present disclosure provides a filter comprising at least one porous composite block according to any one of the first to twelfth embodiments, wherein said plurality of first adsorptive media particles comprises at least one component selected from the group consisting of lead removal media, diatomaceous earth, antimicrobial media or agents, silicas, zeolites, aluminas, ion exchangers, arsenic removal media, molecular sieves, charge-modified particles, titanium silicates, titanium oxides, metal oxides, and metal hydroxides.

In a fourteenth embodiment, the present disclosure provides a filter comprising at least one porous composite block according to any one of the first to thirteenth embodiments, the porous composite block being enclosed within a housing having an inlet opening and an outlet opening and configured to direct a flow of liquid entering the inlet opening, through the porous composite block, and then through the outlet opening to exit the filter.

In a fifteenth embodiment, the present disclosure provides a method of making a porous composite block, the method comprising:

providing components comprising a plurality of primary structures, each primary structure comprising primary adsorptive media particles bonded together by a first polymeric binder and defining a tortuous primary network of pores extending throughout the primary structure;

placing at least a portion of the plurality of primary structures in a cavity of a mold;

heating said at least a portion of the plurality of primary structures to soften the thermoplastic polymeric binder and bond said at least a portion of the plurality of primary structures together; and

cooling the mold to solidify the thermoplastic polymeric binder and form the porous composite block.

In a sixteenth embodiment, the present disclosure provides a method according to the fifteenth embodiment, further comprising compressing said at least a portion of the plurality of primary structures while heating them in the cavity of the mold.

In a seventeenth embodiment, the present disclosure provides a method according to the fifteenth or sixteenth embodiment, wherein the components further comprise secondary polymeric binder particles.

In an eighteenth embodiment, the present disclosure provides a method according to any one of the fifteenth to seventeenth embodiments, wherein void space exterior to the primary structures, in combination with the respective tortuous primary network of pores, forms a tortuous secondary network of pores that extends throughout the porous composite block.

In a nineteenth embodiment, the present disclosure provides a method according to any one of the fifteenth to eighteenth embodiments, wherein at least one of the first polymeric binder or the secondary polymeric binder is selected from the group consisting of polyethylenes, polypropylenes, and combinations thereof.

In a twentieth embodiment, the present disclosure provides a method according to any one of the fifteenth to nineteenth embodiments, wherein at least one of the first polymeric binder or the secondary polymeric binder comprises a high molecular weight polyethylene.

In a twenty-first embodiment, the present disclosure provides a method according to any one of the fifteenth to twentieth embodiments, wherein the components further comprise second adsorptive media particles not included in said plurality of primary structures.

In a twenty-second embodiment, the present disclosure provides a method according to any one of the fifteenth to twenty-first embodiments, wherein at least a portion of the second adsorptive media particles comprise activated carbon.

In a twenty-third embodiment, the present disclosure provides a method according to any one of the fifteenth to twenty-second embodiments, further comprising removing the porous composite block from the cavity of the mold.

In a twenty-fourth embodiment, the present disclosure provides a method according to any one of the fifteenth to twenty-third embodiments, wherein said providing the plurality of primary structures comprises:

providing at least one source block having an initial size and comprised of the adsorptive media particles bonded to one another by the first polymeric binder; and

fragmenting said at least one source block to provide the plurality of primary structures, each primary structure being of a size smaller than the initial size of said at least one source block.

In a twenty-fifth embodiment, the present disclosure provides a method according to any one of the fifteenth to twenty-fourth embodiments, further comprising sorting the plurality of primary structures according to size.

In a twenty-sixth embodiment, the present disclosure provides a method according to any one of the fifteenth to twenty-fifth embodiments, wherein said at least one source block comprises at least two source blocks containing different adsorptive media particles.

In a twenty-seventh embodiment, the present disclosure provides a method according to any one of the fifteenth to twenty-sixth embodiments, wherein at least 80 percent of the primary structures do not pass through a 500 micron screen.

In a twenty-eighth embodiment, the present disclosure provides a method according to any one of the fifteenth to twenty-seventh embodiments, wherein at least 50 percent of the primary structures do not pass through a 4.7 millimeter screen.

In a twenty-ninth embodiment, the present disclosure provides a method according to any one of the fifteenth to twenty-eighth embodiments, wherein at least a portion of the first adsorptive media particles comprise activated carbon.

In a thirtieth embodiment, the present disclosure provides a method according to any one of the fifteenth to twenty-ninth embodiments, wherein the plurality of primary structures comprises a multimodal distribution of sizes.

In a thirty-first embodiment, the present disclosure provides a method according to any one of the fifteenth to thirtieth embodiments, wherein at least a portion of the plurality of primary structures comprises at least one component selected from the group consisting of lead removal media, diatomaceous earth, antimicrobial media or agents, silicas, zeolites, aluminas, ion exchangers, arsenic removal media, molecular sieves, charge-modified particles, titanium silicates, titanium oxides, metal oxides, and metal hydroxides.

Various modifications and alterations of this disclosure may be made by those skilled in the art without departing from the scope and spirit of this disclosure, and it should be understood that this disclosure is not to be unduly limited to the illustrative embodiments set forth herein.

1-31. (canceled)

32. A method of making a porous composite block, the method comprising:
providing components comprising a plurality of primary structures, each primary structure comprising primary adsorptive media particles bonded together by a first polymeric binder and defining a tortuous primary network of pores extending throughout the primary structure, wherein the components further comprise second adsorptive media particles not included in said plurality of primary structures;
placing at least a portion of the plurality of primary structures in a cavity of a mold;
heating said at least a portion of the plurality of primary structures to soften the thermoplastic polymeric binder and bond said at least a portion of the plurality of primary structures together; and
cooling the mold to solidify the thermoplastic polymeric binder and form the porous composite block.

33. The method of claim 32, wherein at least a portion of the second adsorptive media particles comprise activated carbon.

34. The method of claim 32, further comprising removing the porous composite block from the cavity of the mold.

35. A method of making a porous composite block, the method comprising:
providing components comprising a plurality of primary structures, each primary structure comprising primary adsorptive media particles bonded together by a first polymeric binder and defining a tortuous primary network of pores extending throughout the primary structure, wherein providing the plurality of primary structures comprises:
providing at least one source block having an initial size and comprised of the adsorptive media particles bonded to one another by the first polymeric binder; and
fragmenting said at least one source block to provide the plurality of primary structures, each primary structure being of a size smaller than the initial size of said at least one source block;
placing at least a portion of the plurality of primary structures in a cavity of a mold;
heating said at least a portion of the plurality of primary structures to soften the thermoplastic polymeric binder and bond said at least a portion of the plurality of primary structures together; and
cooling the mold to solidify the thermoplastic polymeric binder and form the porous composite block.
